(19) United States
(12) Patent Application Publication
(10) Pub. No.: US 2026/0159130 A1
(43) Pub. Date: Jun. 11, 2026

(54) Apparatus and Method for Operating a Vehicle

(71) Applicant: Bayerische Motoren Werke Aktiengesellschaft, Muenchen (DE)

(72) Inventors: Hubert SCHOLZ, Muenchen (DE); Kai LIU, Muenchen (DE); Natasa MILICIC, Muenchen (DE); Thomas NADER, Muenchen (DE)

(21) Appl. No.: 18/716,600

(22) PCT Filed: Mar. 28, 2024
(86) PCT No.: PCT/EP2024/058468

§ 371 Date: Jun. 5, 2024

(30) Foreign Application Priority Data
Jun. 22, 2023 (DE) 10 2023 116 400.7

(51) Int. Cl. B60W 60/00; B60W 40/08; B60W 50/14; G06V 20/56; G06V 20/59; G06V 40/18

(52) U.S. Cl. CPC B60W 60/0015; B60W 40/08; B60W 50/14; G06V 20/56; G06V 20/597; G06V 40/18; B60W 2040/0818; B60W 2050/146; B60W 2420/403; B60W 2540/225; B60W 2540/229; B60W 2554/4041; B60W 2554/406; B60W 2556/10

(57) ABSTRACT

An apparatus for operating a vehicle includes an environment detection unit which is configured to acquire environment information relating to the environment of the vehicle and to generate environment data corresponding to the environment information, and an occupant detection unit which is configured to acquire an image having an illustration of a vehicle driver of the vehicle and to generate driver image data corresponding to the image. Moreover, the apparatus includes a control unit which is configured to determine, based on the environment data, a driving maneuver of the vehicle which is to be executed by the vehicle within the scope of assisted or automated driving, and to generate maneuver data corresponding to the determined driving maneuver.

### BACKGROUND AND SUMMARY

The invention relates to an apparatus for operating a vehicle. Moreover, the invention relates to a method for operating a vehicle.

In the case of assisted or automated driving, certain driving functions of a vehicle are taken over by a driver assistance system. In contrast to autonomous driving, in the case of assisted or rather automated driving a vehicle driver must be able to take over the driving task at short notice under certain circumstances. To this end, the vehicle driver must always keep an eye on the traffic situation around the vehicle during the assisted or rather automated driving. For this reason, driver assistance systems for assisted or rather automated driving often have systems for monitoring the attention of the vehicle driver.

FR 3 047 957 A1 discloses a lane change assistant of a vehicle. The lane change assistant is designed so as to prevent certain maneuvers of the vehicle in dependence upon the viewing direction of the driver.

DE 10 2021 201 062 A1 discloses a method for operating a motor vehicle. In the case of the method, a comparison is performed as to whether the viewing direction of a driver matches a desired viewing direction. If the viewing direction of the driver does not correspond with the desired viewing direction, a warning sound is output and/or a vehicle function, in particular a partly automated lane change, is not triggered.

DE 10 2013 007 257 A1 discloses a system for operating a motor vehicle in dependence upon the viewing direction. The system is designed so as to determine whether the viewing direction of a driver is directed at a predetermined rearward area if a reverse gear has been selected.

The object of the invention is to propose an apparatus and a method for operating a vehicle, which can better monitor the attention of a vehicle driver of the vehicle in the case of assisted or rather automated driving than hitherto known apparatuses and methods.

This object is achieved by an apparatus and by a method according to the claimed invention.

The proposed apparatus for operating a vehicle comprises an environment detection unit which is designed so as to acquire at least one piece of environment information relating to the environment of the vehicle and to generate environment data corresponding to the environment information, and an occupant detection unit which is designed so as to acquire at least one image having an illustration of a vehicle driver of the vehicle and to generate driver image data corresponding to the image. Moreover, the apparatus comprises a control unit which is designed so as, on the basis of the environment data, to determine at least one driving maneuver of the vehicle which is to be executed by the vehicle within the scope of assisted or rather automated driving, and to generate maneuver data corresponding to the determined driving maneuver. The control unit is moreover designed so as, on the basis of the maneuver data to determine at least two maneuver-specific areas of attention in the field of view of the vehicle driver and at least one maneuver-specific attention criterion of the vehicle driver, to determine, on the basis of the driver image data, whether and how long the view of the vehicle driver is directed in each case at the areas of attention, to generate viewing activity data corresponding to the result of the viewing activity determination, to compare the viewing activity data with the attention criterion and, at least on the basis of this comparison, to generate a control command for the assisted or rather automated driving of the vehicle.

The apparatus monitors whether the vehicle driver is attentively following the assisted or rather automated driving of the vehicle in order to be able to intervene rapidly if necessary. This monitoring is performed in a maneuver-specific manner, in which the control unit determines specific areas of attention for each of the maneuvers that are to be executed. By virtue of the fact that the attention monitoring is performed in a maneuver-specific manner, the attention monitoring can be performed in a more purposeful and consequently more reliable manner. The dynamic generation of the areas of attention renders it possible to also take into consideration the specific conditions in the environment of the vehicle more efficiently than in the case of known apparatuses, in particular in city traffic at intersections, roundabouts and maneuvers at low speed.

In order to perform the maneuver-specific attention monitoring, the control unit first determines which maneuver the vehicle is to execute on the basis of the environment data. For this purpose, the control unit determines a future trajectory of the vehicle, for example, on the basis of the course of the road and the traffic situation in the environment of the vehicle. The control unit then generates the areas of attention in the field of view of the vehicle drive in dependence upon the maneuver that is to be executed. In this document, the field of view of the vehicle driver refers to the areas inside and outside the vehicle that can be seen by the vehicle driver, even if in order to do so the vehicle driver has to turn their head, for example. The control unit also determines the attention criterion. The attention criterion can be defined in advance for a specific maneuver or generated dynamically by the control unit, in particular on the basis of specific specifications. In particular, the attention criterion specifies which of the areas of attention it is absolutely necessary for the attention of the vehicle driver to be directed at. However, the attention criterion can also specify which of the areas of attention the attention of the vehicle driver must not be directed at while the maneuver is being executed. Examples of such areas of attention are the footwell of the vehicle or the central information display of the vehicle. The control unit then compares the viewing activity of the vehicle driver with the attention criterion and controls the vehicle accordingly.

In one example, the vehicle is approaching an intersection and is to turn right in an automated manner. The control unit determines areas of attention on the right-hand side of the vehicle, for example on the right-hand side of the front windscreen and on the right-hand side window of the vehicle. The vehicle only turns right if the vehicle driver has at least looked to the right, otherwise the vehicle remains stationary at the intersection. In another example, the vehicle is to change lanes with assistance. In this example, the control unit determines in particular areas of attention on one of the side windows and the rear window in order to check whether the vehicle driver has looked over their shoulder before changing lanes. By defining multiple areas of attention, different ways of looking over the shoulder can be recognized. For example, not every driver turns their head fully backwards to look over their shoulder.

In this document, assisted driving is understood to mean the automation levels 1 and 2 according to the Federal Highway Research Institute [Bundesanstalt für Straßenwesen]. In this document, automated driving is understood to mean the automation levels 2+ and 3 according to the Federal Highway Research Institute. The environment detection unit is in particular a sensor of the vehicle and is described in more detail in connection with embodiments.

The occupant detection unit comprises in particular an internal camera of the vehicle and is designed in particular so as to detect a two-dimensional image of the vehicle interior compartment. Moreover, the occupant detection unit can be designed so as, in order to generate a sequence of images, to acquire multiple consecutive images which each comprise an illustration of the vehicle driver. In the case of such an embodiment, the driver image data corresponds to the image sequence. The occupant detection unit comprises in particular light in the optical spectrum and/or in the infrared spectrum. Detection of light in the infrared spectrum has the additional advantage that the occupant detection unit can also acquire the image or the image sequence even in poor light conditions, for example at night. As an alternative to an optical camera, the occupant detection unit can also comprise a time-of-flight camera, a RADAR system or a LIDAR system, which generates a three-dimensional image of the vehicle interior compartment, in particular in the form of a point cloud.

In one embodiment, the control unit is designed so as, at least on the basis of the comparison of the viewing activity data with the attention criterion, to determine whether the vehicle driver is attentive and to generate the control command in such a manner that the vehicle only executes the maneuver if the control unit has determined that the vehicle driver is attentive according to the attention criterion. In this embodiment, the vehicle executes the maneuver only if the vehicle driver is attentive according to the attention criterion. Otherwise, the control unit generates the control command, for example, in such a manner that the vehicle safely comes to a stop or that a warning signal is output to the vehicle driver. This increases the road safety in the case of assisted or rather automated driving of the vehicle.

In the case of a further embodiment, the apparatus comprises an input unit of the vehicle. The control unit is designed so as to generate the control command in order to execute the maneuver if the vehicle driver has actuated a predetermined input into the input unit, after the control unit has first determined that the vehicle driver is not attentive according to the attention criterion. In the case of this embodiment, the vehicle driver must explicitly confirm that the maneuver is to be executed. This draws the attention of the vehicle driver to the assisted or rather automated driving of the vehicle and thus increases the road safety. The execution of the maneuver can be linked to further conditions, for example, that the vehicle driver is now attentive according to the attention criterion. In particular, the control unit can be designed so as to control a display unit of the vehicle in order to output a notification to the vehicle driver that they are not attentive and/or that the execution of the maneuver must be confirmed.

In the case of a further embodiment, the attention criterion comprises at least one of the following criteria: a minimum time and/or a maximum time during which the view of the vehicle driver must be directed at a specific area and/or at any area of the areas of attention. In particular, the control unit is designed so as to determine as part of the viewing activity determination for each of the areas of attention whether the view of the vehicle driver is directed longer than the minimum time and/or shorter than the maximum time at the respective area of attention. In the case of this embodiment, the control unit determines areas of attention into which the vehicle driver must have looked at least for a predetermined time, i.e. the minimum time, before the control unit determines that the vehicle driver is attentive according to the attention criterion. In addition, the control unit can also determine that the vehicle driver is not attentive according to the attention criterion when the vehicle driver has looked too long into one of the areas of attention because the vehicle driver is staring absent-mindedly into the respective area of attention, for example. The aforementioned criteria can also be used to monitor the attention of the vehicle driver even more reliably.

In the case of a further embodiment, the control unit is designed so as to allocate points as part of the viewing activity determination and to allocate and/or deduct points depending on whether and for how long the view of the vehicle driver is directed in each case at the areas of attention. The attention criterion comprises at least one minimum number of points which must be at least achieved as part of the viewing activity determination. If the vehicle driver has achieved the minimum number of points, he is considered attentive in terms of the attention criterion. The minimum number of points can be specified in a maneuver-specific manner or can be dynamically determined by the control unit. The points allocation can comprise, for example, allocating points according to time per area of attention. In particular, the points allocation can only commence after the view of the vehicle driver is directed for a minimum time at the respective area of attention. Points can be deducted if the view of the vehicle driver is directed at the respective area of attention longer than a maximum time in order to recognize an absent-minded stare. Specific areas of attention can deduct points, in particular those which lie in the interior compartment of the vehicle, for example, the footwell or the central information display. Moreover, points can be deducted if the view of the vehicle driver is directed at areas outside the areas of attention. Using the points allocation to determine the viewing activity has the advantage that even very different image activities of the vehicle driver can be covered in a simple manner by the minimum number of points. Thus, equal-value areas of attention can add the same point value while the same scenario in different embodiments must be imaged by complicated either/or instructions. This renders it possible to formulate the attention criterion in a particularly simple manner, whereby the apparatus can be implemented in a simpler manner.

In the case of a further embodiment, the control unit is designed so as, on the basis of the environment data and the maneuver data, to determine at least one maneuver focal point in the field of view of the vehicle driver and to determine the areas of attention in such a manner that at least one of the areas of attention comprises the maneuver focal point. The maneuver focal point corresponds to an area in the environment of the vehicle at which the attention of the vehicle driver must be directed in particular before and/or while the maneuver is executed. If points are allocated, more points can be allocated as long as the view of the vehicle driver is directed at an area of attention in the vicinity of the maneuver focal point. Accordingly, fewer points can be allocated the further the area of attention at which the vehicle driver is momentarily looking is away from the maneuver focal point. Moreover, points can also be deducted if the view of the vehicle driver is too far away from the maneuver focal point. The maneuver focal point is thus an important criterion for the determination of the areas of attention and the attention criterion, with which it is possible to perform this determination in a more reliable manner. The more reliably the areas of attention and the attention criterion can be determined, the more reliably the apparatus can monitor the attention of the vehicle driver.

In the case of a further embodiment, the control unit is designed so as, on the basis of the environment data, to determine the position of at least one other road user in the field of view of the vehicle driver and to determine at least one position of the other road user in the area of attention corresponding to the field of view of the vehicle driver. In the case of this embodiment, the other road user can form one of the maneuver focal points. In particular in an environment with vulnerable road users, for example cyclists, pedestrians, scooter riders, etc., the attention of the vehicle driver must be directed at these road users in order to execute the maneuver in a manner safe for traffic. This embodiment implements this realization by determining at least one area of attention corresponding to the position of the other road user. In this way, vulnerable road users in particular can be better protected.

In the case of a further embodiment, the control unit is designed so as, on the basis of the environment data, to determine a traffic situation in the environment of the vehicle, to generate traffic situation data corresponding to the traffic situation and to determine the areas of attention taking into consideration the traffic situation data. The traffic situation includes, for example, whether the roadway in front of the vehicle is blocked, whether the vehicle is in a traffic jam or whether and/or how many other vehicles and/or other road users are around the vehicle. In this embodiment, the control unit determines the areas of attention taking into consideration the traffic situation in the environment of the vehicle and can therefore react dynamically to unexpected situations, for example in an urban environment. This can further increase road safety in the case of assisted or rather automated driving of the vehicle.

In the case of a further embodiment, the environment detection unit comprises at least one image acquisition unit of the vehicle, which is designed to acquire at least one image having an illustration of the environment of the vehicle as the environment information and to generate exterior image data corresponding to the image. The environment data comprises the exterior image data. The image acquisition unit of the vehicle is, in particular, a camera of the vehicle. Alternatively, the image acquisition unit can also comprise a time-of-flight camera, a RADAR system or a LIDAR system, which generates a three-dimensional image of the environment of the vehicle, in particular in the form of a point cloud. A multiplicity of important features can be reliably extracted from the image of the environment of the vehicle, for example traffic signs, traffic lights, road markings, the position of other road users and other information relating to the traffic situation. The features can be extracted, for example, using a machine learning method, in particular a machine learning method that specializes in machine vision, such as a convolutional neural network.

In the case of a further embodiment, the environment detection unit comprises at least one navigation unit which is designed so as to acquire and/or receive at least one piece of navigation information relating to the vehicle and to generate navigation data corresponding to the navigation information. The environment data comprises the navigation data. For example, the navigation unit can be a navigation unit of the vehicle. Alternatively or in addition, the navigation unit can also be designed so as to receive navigation data, for example from a mobile end device that is brought into the vehicle. The navigation information is in particular a road map of the environment of the vehicle but also a position of the vehicle in a world coordinate system or traffic information, for example traffic jam information. On the basis of the navigation information, the control unit can determine in a particularly reliable manner the maneuver that is to be executed. For example, the control unit can plan a trajectory on the basis of the road map of the environment of the vehicle or determine that an intersection needs to be crossed.

In the case of a further embodiment, the control unit is designed so as, on the basis of the driver image data, to determine a viewing direction and/or head pose of the vehicle driver, to determine viewing direction data corresponding to the viewing direction and/or head pose of the vehicle driver and to perform the viewing activity determination taking into consideration the viewing direction data. The viewing direction and/or the head pose, i.e. the orientation and position of the occupant's head, can be determined from the driver image data in particular using a suitable machine learning method. The viewing direction can be determined in particular from the orientation of the pupil of the vehicle driver. Both the viewing direction and also the head pose of the vehicle driver render it possible to determine very precisely what the vehicle driver is looking at. As a result, it is possible to determine the viewing activity and consequently monitor the attention of the vehicle driver in an even more reliable manner.

In the case of a further embodiment, the control unit is designed so as to store viewing direction data in a memory storage area of the control unit and to determine the areas of attention taking into consideration viewing direction data that is stored in the past. In the case of this embodiment, the apparatus learns the special viewing habits of the vehicle driver, for example how the vehicle driver looks over their shoulder. Taking into consideration this information, the areas of attention can be determined in a manner directed at the vehicle driver. This makes the monitoring of the attention of the vehicle driver even more reliable.

In the case of a further embodiment, the control unit is designed so as, on the basis of the driver image data, to determine at least one characteristic of the vehicle driver which is related to the driving task of the vehicle driver, to generate characteristic data corresponding to the characteristic and, taking into consideration the characteristic data, to generate the control command for assisted or rather automated driving of the vehicle. The characteristic can be, for example, whether the vehicle driver is holding the steering wheel or whether the vehicle driver is momentarily actively controlling the vehicle. However, the characteristic can also be a physiological size, for example an eyelid blink frequency, from which it is possible to determine the attention of the vehicle driver. If points are allocated, the control unit can already take into consideration the characteristic data when determining the viewing activity. The presence of a specific characteristic, for example whether the vehicle driver holds the steering wheel, can produce additional points. The presence of other characteristics, for example a microsleep of the vehicle driver that is recognized with the aid of the eye lid blink frequency, can lead to points being deducted. In the case of such an embodiment, the characteristic data flows into the generation of the control command for the assisted or rather automated driving of the vehicle via the viewing activity data. By taking the characteristic of the vehicle driver into consideration, the attention of the vehicle driver can be determined even more reliably.

In the case of a further embodiment, the control unit is designed so as to actuate at least one display unit of the vehicle in order to display the areas of attention and/or the status of the viewing activity determination to the vehicle driver. The display unit can be, for example, a screen, in particular a screen of a dashboard of the vehicle or a central information display. However, the display unit can also be a head-up display, in particular a panoramic head-up display. Furthermore, the display unit can also be a light strip on the windscreen root of the front windscreen, which indicates the areas of attention and/or the status of the viewing activity determination using different colors. The display on the display unit directs the attention of the vehicle driver at the areas of attention or rather the viewing activity determination, which increases road safety.

Moreover, the invention relates to a method for operating a vehicle. In the method, at least one piece of environment information relating to the environment of the vehicle is acquired and environment data corresponding to the environment information is generated. At least one image having an illustration of a vehicle driver of the vehicle is acquired and driver image data corresponding to the image is generated. At least one driving maneuver of the vehicle that is to be executed by the vehicle within the scope of assisted or rather automated driving is determined on the basis of the environment data. Maneuver data corresponding to the determined driving maneuver is generated. At least two maneuver-specific areas of attention in the field of view of the vehicle driver and at least one maneuver-specific attention criterion relating to the viewing activity of the vehicle driver are determined on the basis of the maneuver data. The driver image data is used to determine whether and for how long the view of the vehicle driver is directed at each of the areas of attention. Viewing activity data corresponding to the result of this viewing activity determination is generated. The viewing activity data is compared with the attention criterion. Furthermore, a control command for assisted or rather automated driving of the vehicle is generated at least on the basis of this comparison.

The method has the same advantages as the claimed apparatus. In particular, the method can be developed with the features of the dependent claims that are directed at the apparatus. Furthermore, the apparatus described above can be developed with the features which are described in this document in connection with the method.

Exemplary embodiments of the invention are explained below with reference to the figures.

### BRIEF DESCRIPTION OF THE DRAWINGS

FIG. 1 shows a schematic illustration of an apparatus for operating a vehicle.

FIG. 2 shows a flowchart of a method for operating the vehicle.

### DETAILED DESCRIPTION OF THE DRAWINGS

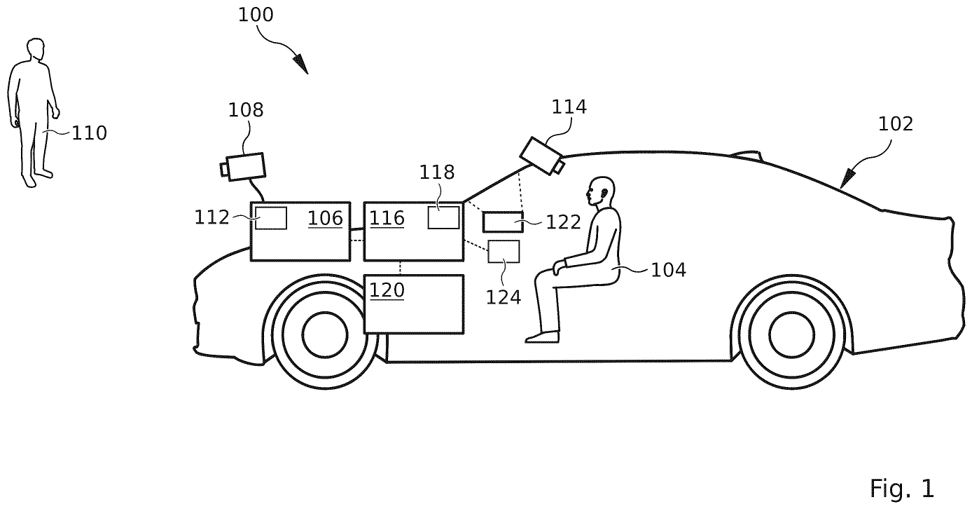

FIG. 1 shows a schematic illustration of an apparatus 100 for operating a vehicle 102.

The apparatus 100 monitors the attention of a vehicle driver 104 of the vehicle 102 in the case of assisted or automated driving of the vehicle 102. For this purpose, the apparatus 100 first determines which maneuver the vehicle 102 is to execute within the scope of the assisted or automated driving. The apparatus 100 then determines areas of attention in the field of view of the vehicle driver 104 which are specific for the maneuver that is to be executed. The apparatus 100 then determines whether and how long the view of the vehicle driver 104 is directed at the areas of attention and compares the determined viewing activity of the vehicle driver 104 with an attention criterion that has been previously defined in a likewise maneuver-specific manner. Only when the vehicle driver 104 is attentive in terms of the attention criterion is the maneuver executed as planned.

The apparatus 100 comprises an environment detection unit 106 for acquiring at least one piece of environment information relating to the environment of the vehicle 102. The environment detection unit 106 comprises an image acquisition unit 108 which is designed purely by way of example as a camera. The image acquisition unit 108 is arranged is such a manner and designed so as to acquire as the environment information an image having an illustration of an area outside the vehicle 102 and to generate image data corresponding to the image. In the example illustrated in FIG. 1, the image comprises an illustration of another road user 110 who is illustrated only purely by way of example as a pedestrian. The image acquisition unit 108 can also be designed so as to acquire an image sequence of multiple consecutive images and to generate image data corresponding to the image sequence.

Moreover, the environment detection unit 106 comprises a navigation unit 112 for acquiring and/or providing a piece of navigation information relating to the vehicle 102, for example a road map of the environment of the vehicle 102 or the current position of the vehicle 102 in a world coordinate system. The navigation unit 112 generates the navigation data corresponding to the navigation information. The environment detection unit 106 provides the navigation data together with image data as environment data.

The apparatus 100 comprises in addition an occupant detection unit 114 for acquiring at least one image having an illustration of the vehicle driver 104. The occupant detection unit 114 is designed purely by way of example as an internal camera of the vehicle 102 which is oriented in such a manner and designed so as to acquire at least one image having an illustration of the vehicle interior compartment and to generate driver image data corresponding to the image. The occupant detection unit 114 can also be designed so as to acquire an image sequence of multiple consecutive images and to generate driver image data corresponding to the image sequence.

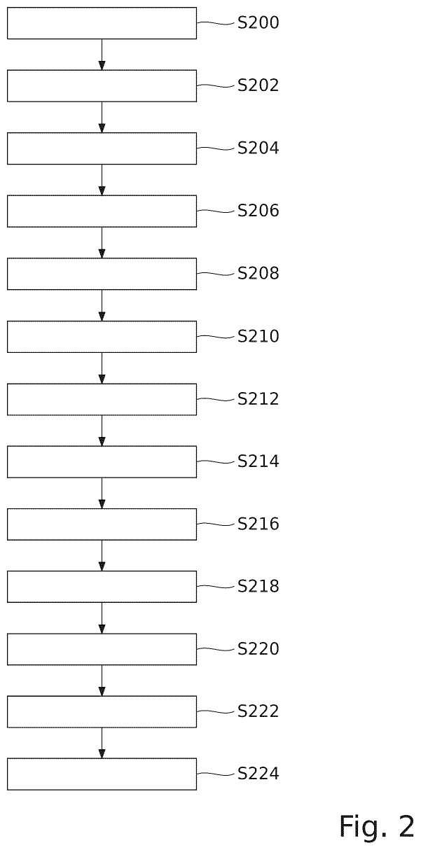

Moreover, the apparatus 100 comprises a control unit 116 which is illustrated purely by way of example as a part of the vehicle 102. The control unit 116 comprises a memory storage area 118 in which the control unit 116 can store data and from which the control unit 116 can read stored data. The control unit 116 is further designed so as to actuate at least the aforementioned functional units of the apparatus 100 in order to perform a method for operating the vehicle 102. In the case of the method, the control unit 116 first determines, with the aid of the environment data, the driving maneuver that is to be executed and generates maneuver data corresponding to the driving maneuver. The control unit 116 then determines at least on the basis of the maneuver data the maneuver-specific areas of attention and the maneuver-specific attention criterion. Using the driver image data, the control unit 116 then determines the viewing activity of the vehicle driver 104 and generates viewing activity data corresponding to the viewing activity. The control unit 116 compares the viewing activity data with the attention criterion and based on this comparison generates a control command for the assisted or rather automated driving of the vehicle 102. The control unit 116 then transmits the control command to a functional unit 120 of the vehicle 102, in particular to an actuator, a drive system, a braking system and/or a steering system. The method for operating the vehicle 102 is described in more detail below with reference to FIG. 2.

In the exemplary embodiment illustrated in FIG. 1, the control unit 116 is in addition designed so as to actuate a display unit 122 of the vehicle 102. The display unit 122 is purely by way of example designed as a head-up-display. The control unit 116 can actuate the display unit 122 in order to display by way of example the areas of attention and/or the status of the viewing activity determination. Moreover, according to the exemplary embodiment illustrated in FIG. 1, the control unit 116 is designed so as to receive an input of the vehicle driver 104 from an input unit 124 of the apparatus 100.

FIG. 2 shows a flowchart of a method for operating the vehicle 102.

The method is started in step S200. In step S202, the control unit 116 actuates the environment detection unit 106 so as to acquire the environment information and to provide the environment data. By way of example, the control unit 116 actuates the image acquisition unit 108 so as to acquire the image of the environment of the vehicle 102 and provide this as the image data. In another example, the control unit 116 actuates the navigation unit 112 so as to acquire a road map of the environment of the vehicle 102 and provide this as the navigation data. In step S204, the control unit 116 actuates the occupant detection unit 114 so as to acquire the image of the vehicle driver 104 and to provide the driver image data. The steps S202 and S204 can be performed simultaneously or consecutively in any sequence.

In step S206, the control unit 116 determines, on the basis of the environment data, the maneuver that is to be executed by the vehicle 102 within the scope of the assisted or rather automated driving. In one example, the control unit 116 determines, with the aid of the image data, for example using a machine learning method that specializes in machine vision, that the vehicle 102 is approaching a red traffic light. In a further example, the control unit 116 determines, with the aid of the navigation data, that the vehicle 102 is approaching an intersection. The control unit 116 generates the maneuver data corresponding to the determined maneuver.

In the optional step S208, the control unit 116 determines, on the basis of the environment data and the maneuver data, at least one maneuver focus point in the field of view of the vehicle driver 104. The maneuver focal point is a point or area in the field of view of the vehicle driver 104 that the vehicle driver 104 must be able to see in order for the maneuver to be executed in a manner safe for traffic. In the optional step S210, the control unit 116 determines, on the basis of the environment data, the position at least of one further road user 110 in the field of view of the vehicle driver 104. In one example, the control unit 116 determines with the aid of the image data that a pedestrian is currently crossing a pedestrian crossing which the vehicle 102 is approaching. In the optional step S212, the control unit 116 determines, on the basis of the environment data, a traffic situation in the environment of the vehicle 102. In one example, the control unit 116 determines, with the aid of the image data, that the roadway in front of vehicle 102 is temporarily blocked by a road works. The optional steps S208 to S212 can be performed simultaneously or consecutively in any sequence.

In step S214, the control unit 116 determines, at least with the aid of the maneuver data, at least two areas of attention in the field of view of the vehicle driver 104 and at least one attention criterion relating to the viewing activity of the vehicle driver 104. Both the areas of attention and also the attention criterion are maneuver-specific, in other words relate to the specific maneuver that is to be executed by the vehicle 102. The control unit 116 can actuate the display unit 122 in step S214 in order to display the areas of attention to the vehicle driver 104. If step S208 has been performed, the control unit 116 determines the areas of attention in such a manner that at least one of the areas of attention comprises the maneuver focal point. If step S210 has been performed, the control unit 116 determines the areas of attention in such a manner that at least one of the areas of attention comprises the position of the other road user 110 in the field of view of the vehicle driver 104. If step S212 has been performed, the control unit 116 determines the areas of attention and the attention criterion taking into consideration the determined traffic situation.

In one example, the vehicle 102 is to make an assisted or rather automated right turn. A cyclist approaches vehicle 102 from behind on the right-hand side. In step S210, the control unit 116 recognizes the cyclist as another road user. In step S214, the control unit 116 determines the areas of attention in such a manner that a right-hand side window of the vehicle 102, a rear-view mirror of the vehicle 102, a right-hand side mirror of the vehicle 102 and the cyclist are each covered by at least one of the areas of attention. The control unit 116 determines the attention criterion in such a manner that the vehicle driver 104 must in any case perceive the cyclist before the vehicle 102 executes the turning maneuver.

In step S216, the control unit 116 performs the viewing activity determination, in which the control unit 116 determines, with the aid of the driver image data, whether and how long the view of the vehicle driver 104 is directed in each case at the areas of attention. For this purpose, the control unit 116 can determine from the image data the viewing direction of the vehicle driver 104. In particular if the vehicle driver 104, by way of example when looking over their shoulder, turns their head away from the occupant detection unit 114, the precise viewing direction can possibly not be determined from the image data. Therefore, the control unit 116 alternatively or in addition can also determine a head pose of the vehicle driver 104. Moreover, the control unit 116 generates the viewing activity data corresponding to the determined viewing activity of the vehicle driver 104. Optionally, the control unit 116 can store this viewing activity data in the memory storage area 118 of the control unit 116 for a longer period of time. If stored viewing activity data of the vehicle driver 104 is available, the control unit 116 can determine in step S214 the areas of attention taking into consideration the viewing activity data of the vehicle driver 104. Consequently, the apparatus 100 can take into consideration the specific viewing habits of the vehicle driver 104 when determining the areas of attention.

In the optional step S218, the control unit 116 determines, on the basis of the driver image data, at least one characteristic of the vehicle driver 104 which relates to the driving task of the vehicle driver 104. By way of example, the control unit 116 determines, on the basis of the driver image data, whether the vehicle driver 104 is holding the steering wheel of the vehicle 102. The control unit 116 generates the characteristic data corresponding to the characteristic.

In step S220, the control unit 116 compares the viewing activity data with the attention criterion in order to determine whether the vehicle driver 104 is attentive according to the attention criterion and the maneuver can be executed in a manner safe to traffic. For this purpose, the control unit 116 can perform a points allocation and allocate points per time unit which the vehicle driver 104 is looking at specific areas of attention. In particular, the control unit 116 can allocate more points for areas of attention which lie closer to the maneuver focal point and/or the other road user. Accordingly, the control unit 116 can allocate fewer points for areas of attention which lie further away from the maneuver focal point and/or the other road user. The control unit 116 can also deduct points if the view of the vehicle driver 104 is directed too far away from the maneuver focal point and/or the other road user or if the vehicle driver 104 is looking at the areas of attention which correspond by way of example to the footwell of the vehicle 102 or a central information display. The attention criterion can correspond in such an embodiment to a minimum number of points which the vehicle driver 104 must achieve in order to be considered attentive in terms of the attention criterion. However, additional conditions may also be imposed, for example that the vehicle driver 104 must have been looking at the area of attention corresponding to the position of the other road user 110 in their field of view, i.e. that the vehicle driver 104 must have seen the other road user in any case. If the step S218 has been performed, it is possible on the basis of the characteristic data for further points to be allocated. Moreover, the attention criterion can define a minimum time and/or a maximum time which the vehicle driver 104 must look at specific areas of attention in order to be considered attentive. Moreover, the attention criterion can also define that a certain percentage of the areas of attention must be viewed by the vehicle driver 104 within a predetermined period of time for the vehicle driver 104 to be considered attentive. The control unit 116 can actuate the display unit 122 in step S220 in order to display the status of the viewing activity determination to the vehicle driver 104.

In step S222, the control unit 116 generates, on the basis of the result of step S220, the control command for the assisted or rather automated driving of the vehicle 102 and transmits the control command to the functional unit 120. In particular, the control unit 116 generates the control command in such a manner that the vehicle 102 only executes the maneuver if the control unit 116 has determined in step S220 that the vehicle driver 104 is attentive according to the attention criterion. If the control unit 116 has determined in step S220 that the vehicle driver 104 is not attentive according to the attention criterion, the execution of the maneuver can be made dependent on an input from the vehicle driver 104 into the input unit 124, with which the vehicle driver 104 confirms that the maneuver is to be executed. The method is terminated in step S224.

A single driving maneuver, for example driving across an intersection, can in particular be broken down into multiple maneuvers in terms of the method described here, for which in each case steps S202 to S222 are repeated. In a first maneuver, the vehicle 102 approaches the intersection and comes to a stop at a stop line. In step S214, the control unit 116 determines areas of attention that cover a wide field of view, since the entire traffic area around the vehicle 102 is to be monitored by the vehicle driver 104. In a second maneuver, the vehicle 102 moves off. In step S214, the control unit 116 determines areas of attention that are focused closely to the front right, since no one is to be endangered who is in front of the vehicle 102 when the vehicle 102 starts off, for example a pedestrian who is crossing the roadway. In a third maneuver, the vehicle 102 finally drives across the intersection. In step S214, the control unit 116 determines areas of attention that again cover a wide field of view. In addition, the control unit 116 determines areas of attention that correspond in each case to the position of other road users along the trajectory of the vehicle 102 in the field of view of the vehicle driver 104.

In the embodiment example described with reference to FIGS. 1 and 2, at least the environment detection unit 106, the occupant detection unit 114 and the control unit 116 form the apparatus 100 for operating the vehicle 102. Other elements and features shown in FIGS. 1 and 2 and mentioned in the preceding description can be part of the claimed apparatus 100. Similarly, method steps described with reference to the apparatus 100 can be part of the claimed method.

### List of Reference Characters

100 Apparatus
102 Vehicle
104 Vehicle driver
106 Environment detection unit
108 Image acquisition unit
110 Road user
112 Navigation unit
114 Occupant detection unit
116 Control unit
118 Memory storage area
120 Functional unit
122 Display unit
124 Input unit

1.-15. (canceled)

16. An apparatus for operating a vehicle, the apparatus comprising:
an environment detection unit which is configured to acquire environment information relating to an environment of the vehicle and to generate environment data corresponding to the environment information;
an occupant detection unit which is configured to acquire an image having an illustration of a vehicle driver of the vehicle and to generate driver image data corresponding to the image; and
a control unit which is configured to determine, based on the environment data, a driving maneuver of the vehicle which is to be executed by the vehicle within a scope of assisted or automated driving, and to generate maneuver data corresponding to the determined driving maneuver,
wherein the control unit is further configured to determine, based on the maneuver data, at least two maneuver-specific areas of attention in a field of view of the vehicle driver and at least one maneuver-specific attention criterion which is related to viewing activity of the vehicle driver; to determine, based on the driver image data, whether and how long the view of the vehicle driver is directed at areas of attention; to generate viewing activity data corresponding to a result of the viewing activity determination; to compare the viewing activity data with the attention criterion; and, based at least on a result of the comparison, to generate a control command for the assisted or automated driving of the vehicle.

17. The apparatus according to claim 16, wherein the control unit is further configured to determine, based at least on the comparison of the viewing activity data with the attention criterion, whether the vehicle driver is attentive and to generate the control command such that the vehicle only executes the maneuver when the control unit has determined that the vehicle driver is attentive according to the attention criterion.

18. The apparatus according to claim 17, further comprising an input unit of the vehicle, wherein the control unit is further configured to generate the control command in order to execute the maneuver when the vehicle driver has actuated a predetermined input into the input unit after the control unit has first determined that the vehicle driver is not attentive according to the attention criterion.

19. The apparatus according to claim 16, wherein the attention criterion comprises a minimum time and/or a maximum time during which the view of the vehicle driver must be directed at a specific area and/or at any area of the areas of attention.

20. The apparatus according to claim 16, wherein the control unit is further configured to perform, as part of the viewing activity determination, a points allocation and allocate and/or deduct points depending on whether and for how long the view of the vehicle driver is directed at the areas of attention; and wherein the attention criterion comprises a minimum number of points which must be at least achieved as part of the viewing activity determination.

21. The apparatus according to claim 16, wherein the control unit is further configured to determine, based on the environment data and the maneuver data, a maneuver focal point in the field of view of the vehicle driver and to determine the areas of attention such that at least one of the areas of attention comprises the maneuver focal point.

22. The apparatus according to claim 16, wherein the control unit is further configured to determine, based on the environment data, a position of another road user in the field of view of the vehicle driver and to determine a position of the other road user in an area of attention corresponding to the field of view of the vehicle driver.

23. The apparatus according to claim 16, wherein the control unit is further configured to determine, based on the environment data, a traffic situation in the environment of the vehicle, to generate traffic situation data corresponding to the traffic situation, and to determine the areas of attention taking into consideration the traffic situation data.

24. The apparatus according to claim 16, wherein the environment detection unit comprises an image acquisition unit of the vehicle which is configured to acquire as the environment information an image having an illustration of the environment of the vehicle and to generate exterior image data corresponding to the image; and wherein the environment data comprises the exterior image data.

25. The apparatus according to claim 16, wherein the environment detection unit comprises a navigation unit which is configured to acquire and/or receive navigation information relating to the vehicle and to generate navigation data corresponding to the navigation information; and wherein the environment data comprises the navigation data.

26. The apparatus according to claim 16, wherein the control unit is further configured to determine, based on the driver image data, a viewing direction and/or a head pose of the vehicle driver, to determine viewing direction data corresponding to the viewing direction and/or the head pose of the vehicle driver, and to perform the viewing activity determination taking into consideration the viewing direction data.

27. The apparatus according to claim 26, wherein the control unit is further configured to store the viewing direction data in a memory storage area of the control unit and to determine the areas of attention taking into consideration viewing direction data that is stored in the past.

28. The apparatus according to claim 16, wherein the control unit is further configured to determine, based on the driver image data, a characteristic of the vehicle driver which is related to a driving task of the vehicle driver, to generate characteristic data corresponding to the characteristic and, taking into consideration the characteristic data, to generate the control command for the assisted or automated driving of the vehicle.

29. The apparatus according to claim 16, wherein the control unit is further configured to actuate a display unit of the vehicle in order to display the areas of attention and/or a status of the viewing activity determination to the vehicle driver.

30. A method for operating a vehicle, the method comprising:
acquiring environment information relating to an environment of the vehicle and generating environment data corresponding to the environment information;
acquiring an image having an illustration of a vehicle driver of the vehicle and generating driver image data corresponding to the image;
based on the environment data, determining a driving maneuver of the vehicle which is to be executed by the vehicle within a scope of assisted or automated driving, and generating maneuver data corresponding to the determined driving maneuver;
based on the maneuver data, determining at least two maneuver-specific areas of attention in a field of view of the vehicle driver and at least one maneuver-specific attention criterion relating to viewing activity of the vehicle driver;
based on the driver image data, determining whether and how long the view of the vehicle driver is directed at areas of attention and generating viewing activity data corresponding to a result of the viewing activity determination;
comparing the viewing activity data with the attention criterion; and
based at least on a result of the comparison, generating a control command for the assisted or automated driving of the vehicle.
